(19) United States
(12) Patent Application Publication
(10) Pub. No.: US 2005/0062692 A1
(43) Pub. Date: Mar. 24, 2005

(54) Current driving apparatus and method for active matrix OLED

(76) Inventors: Shin-Tai Lo, Miaoli City (TW); Chih-Chung Chien, Taichung (TW)

Correspondence Address: BIRCH STEWART KOLASCH & BIRCH, PO BOX 747, FALLS CHURCH, VA, 22040-0747, US

(21) Appl. No.: 10/665,534

(22) Filed: Sep. 22, 2003

(51) Int. Cl. G09G 3/30

(52) U.S. Cl. 345/76; 345/82

(57) ABSTRACT

A current driving apparatus and method for active matrix organic light emitting diode (AMOLED) includes two abutting sub-pixels (an odd sub-pixel and an even sub-pixel). The driving apparatus of each sub-pixel includes a writing element, a switching element, a driving element, a control element, a storage element, and a light emission element. The driving circuit includes odd line enable for the odd sub-pixels, even line enable for the even sub-pixels, a dataline shared by odd sub-pixels and even sub-pixels, a scan line, a supply line, and a common line. The invention can improve the uniformity of the AMOLED panel and reduce the number of required data line.

### FIELD OF THE INVENTION

The present invention relates to a current driving apparatus and method for active matrix organic light emitting diode display (AMOLED) and particularly to the driving apparatus and method for data current programming to improve image uniformity of AMOLED panels.

### BACKGROUND OF THE INVENTION

The methods for driving OLED can be divided into passive matrix OLED (PMOLED) and active matrix OLED (AMOLED). The AMOLED uses thin-film transistors (TFTs) and capacitors to store signals for controlling the brightness and gray scale of the OLED. Although the cost and technical threshold for fabrication of the PMOLED are lower, the products of PMOLED are still limited to about 5 inches in size and the resolution cannot be increased due to the constraint of the driving method. Thus they are restricted in the market of low resolution and small dimension. To achieve a higher resolution and a larger screen, active driving method must be used. The active driving method uses capacitors to store signals, so that the pixel can still maintain the original brightness after scanning. In the passive driving, only the pixel that is selected by the scan line will be lighted. Thus under the active driving method, OLED does not need to be driven to a very great brightness. As a result, it has a longer service life and can achieve a higher resolution. To link OLED with TFT technology makes active driving of OLED possible, and meets the market demands for the smoothness of display and ever-higher resolution.

The technologies for growing TFT on the glass substrate can be amorphous silicon (a-Si) process and low temperature poly-silicon (LTPS) process. The main differences between LTPS TFT and a-Si TFT are in electricity and manufacturing complexity. LTPS TFT has a higher carrier-mobility which means that TFT can better provide sufficient current, but its manufacturing process is more complicated. By contrast, a-Si TFT has a lower carrier mobility than LTPS, but its manufacturing process is simpler and well developed, and therefore a-Si TFT has a better competitiveness in terms of cost.

Because of the constraints in manufacturing process of LTPS, the TFT elements being fabricated have variations in threshold voltage and electron mobility. As a result, each TFT element has different characteristics. When the driving system adopts analog voltage-modulation to achieve gray level, even if the input data voltages are the same, the OLEDs generate different output currents such that the OLEDs of different pixels on the display panel will display different brightness due to different characteristics of TFT for different pixels. This phenomenon causes the ill gray level on OLED display panel and severely damages image-uniformity of the panel.

To mend the aforementioned drawback, i.e. the image uniformity of the panel, U.S. Pat. No. 6,229,506 entitled “Active Matrix Light Emitting Diode Pixel Structure and Concomitant Method” proposed a data current programming mechanism to compensate the variations of TFT threshold voltage and electron-mobility so as to improve image uniformity. FIG. 3 illustrates the schematic diagram of pixel-circuit used in U.S. Pat. No. 6,229,506. The operation-principle of the circuit is described as follows:

During scanning, transistors P1 and P3 are ON while transistor N1 is OFF. At this time, the data-current □I_{data}□on data-line 31 passes through the transistor P1. If the data-current □I_{data}□ is not equal to the current □Iₚ₂□that passes through the transistor P2, then a current I_{c} will charge or discharge a storage element Cs. The I_{c} is the difference of I_{data} and Iₚ₂. The charging (discharging) operation for the storage element Cs increases (decreases) the current Iₚ₂. And the charging or discharging operation in the storage element Cs will continue until the current Iₚ₂ is equal to data-current □I_{data}□. When the current Iₚ₂ is equal to data-current □I_{data}□, the potential difference between two ends of the storage element Cs is Vsg (potential difference between the source and the gate) needed for the transistor P2 to ensure Iₚ₂ is equal to I_{data}. Thereafter, the transistors P1 and P3 are turned off to finish data current programming operation, and then the displaying stage starts. In the displaying stage, the S end (source end) of transistor P2 connects to the power supply line 33 due to transistor N1 being turned on. Because the potential difference between two ends of the storage element Cs is just equal to the Vsg that is needed for P2 to ensure Iₚ₂ is equal to the data-current □I_{data}□. Therefore, the current flowing through OLED 34 is equal to the current Iₚ₂, i.e. data-current □I_{data}□, such that the brightness of the OLED 34 corresponds to the data-current □I_{data}□.

The driving structure based on the pixel-circuit technology for the OLED display is shown in FIG. 4. A frame 40 (1 frame=1/60 second) starts from the first scan line of the present frame 40 by a write operation 401 for data current programming. The potential difference between two ends of the storage element Cs of the pixel offers the Vsg that is required when the current passing through the transistor P2 equals the data current □I_{data}□. After the first scan line 32 has completed the write operation 401, a second scan line 32 performs the write operation 401 for the present frame 40, meanwhile a current equals the data current passing through an OLED element 34 on the first scan line 32 to make the OLED element 34 of the first scan line 32 to perform display operation 402.

After the second scan line 32 has completed the write operation 401, the third scan line 32 in turn performs the write operation 401 of data current for the present frame 40, meanwhile a current equals the data current passing through an OLED element 34 on the second scan line 32 to make the OLED element 34 of the second scan line 32 to perform display operation 402.

The process proceeds in sequence until the last scan line 32 has completed the write operation 401 for the existing frame 40. Then, the write operation 401 is repeated from the beginning, the first scan line 32 executes the write operation 401 of data current for the next frame 40.

However, the foregoing description of the patent has to use P-Type and N-Type CMOS LTPS TFT manufacturing processes. The processes are relatively more complicated and the production cost is higher.

### SUMMARY OF THE INVENTION

Therefore, the primary object of this invention is to solve the traditional disadvantages that are aforementioned. The invention provides a driving method for data current programmed to compensate the variations of threshold voltage and electron mobility of TFT elements so as to solve the problem of image non-uniformity of the AMLOED panel. Through the invention, the number of data-lines can be reduced to the number of a half for conventional designs. Thus the production cost can also be reduced.

In order to achieve the foregoing object, the driving apparatus of the invention includes two abutting sub-pixels (an odd sub-pixel and an even sub-pixel). The driving apparatus of each sub-pixel consists of four TFTs and one capacitor. In addition, each sub-pixel includes a writing element, a switching element, a driving element, a control element, a storage element, and a light emission element. The driving circuit includes odd line enable for the odd sub-pixels, even line enable for the even sub-pixels, a data line shared by odd sub-pixels and even sub-pixels, a scan line, a supply line, and a common line.

The foregoing, as well as additional objects, features and advantages of the invention will be more readily apparent from the following description, which proceeds with reference to the accompanying drawings.

### BRIEF DESCRIPTION FOR THE DRAWINGS

FIG. 1 is a schematic diagram of the apparatus of the invention.

FIG. 2 is the driving scheme for FIG. 1.

FIG. 3 is a schematic diagram for the pixel circuit of U.S. Pat. No. 6,229,506.

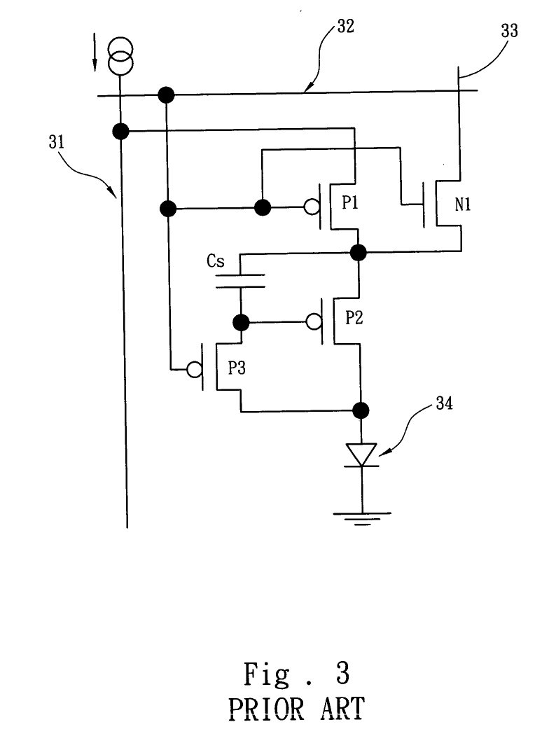

FIG. 4 is a schematic diagram of the driving scheme for FIG. 3.

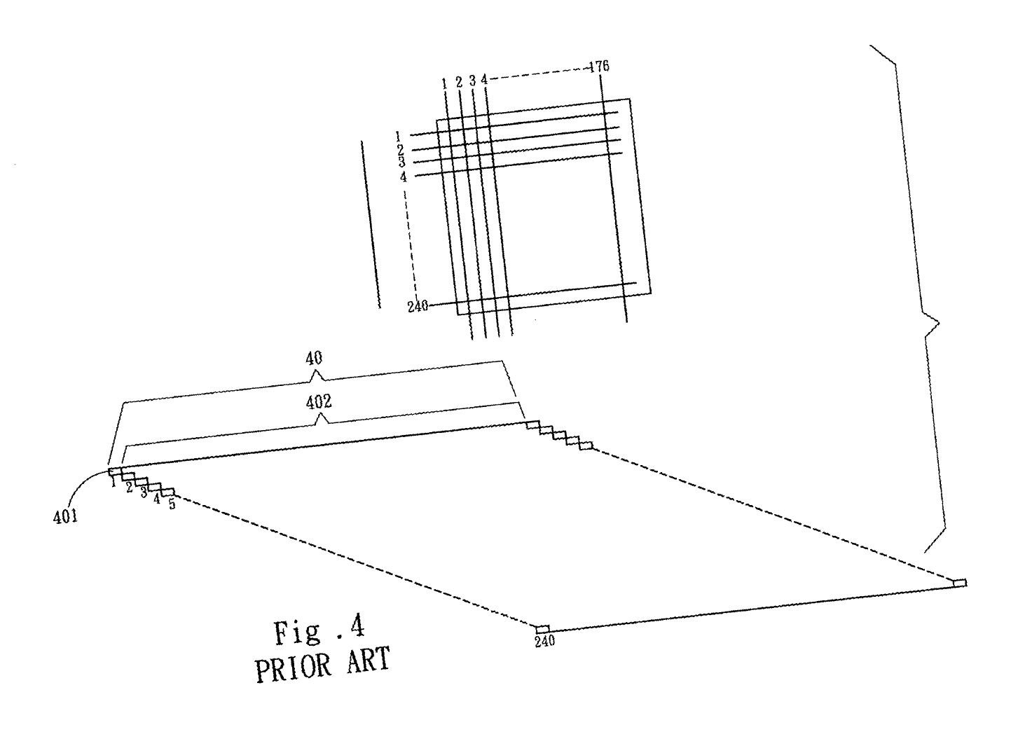

### DESCRIPTION OF THE PREFERRED EMBODIMENT

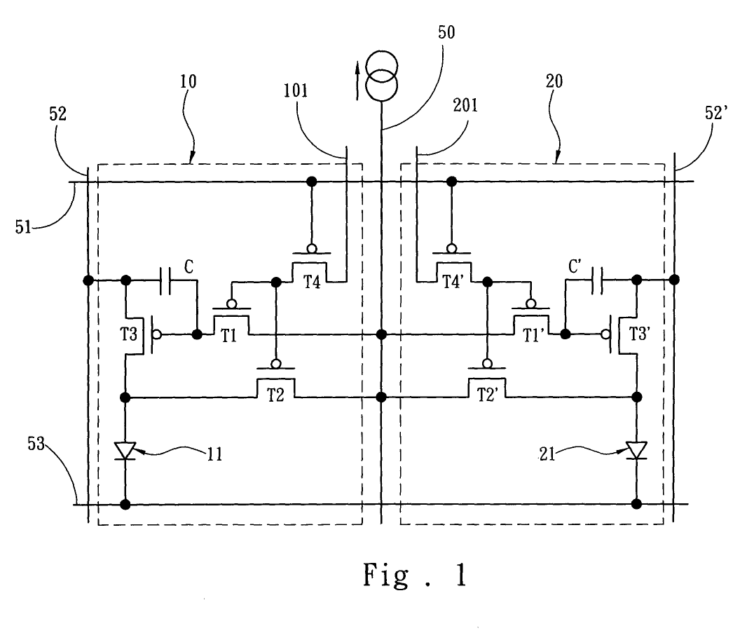

Referring to FIG. 1, which is a schematic diagram of the apparatus of the invention. According to the figure, the driving apparatus proposed in this invention includes two abutting sub-pixels (an odd sub-pixel 10 and an even sub-pixel 20). The driving apparatus of each sub-pixel consists of four TFTs and one capacitor. The odd sub-pixel 10 and the even sub-pixel 20 respectively include a writing element T1 and T1′, a switching element T2 and T2′, a driving element T3 and T3′, a control element T4 and T4′, a storage element C and C′, and a light emission element 11 and 21. The driving circuit includes an odd line enable 101 for the odd sub-pixel 10 and a supply line 52; and an even line enable 201 for the even sub-pixel 20, and a supply line 52′; a data line 50 shared by the odd sub-pixel 10 and the even sub-pixel 20, a scan line 51; and a common line 53.

The sources of the writing elements TI and T1′ are connected to the data line 50. The gates of the switching elements T2 and T2′ are respectively connected to the gates of the writing elements T1 and T1′, and the sources of the switching elements T2 and T2′ are also connected to the data line 50. The gates of the driving elements T3 and T3′ are connected to the drains of the writing elements T1 and T1′ correspondingly, and the sources of the driving elements T3 and T3′ are respectively connected to the supply lines 52 and 52′. The gates of the control elements T4 and T4′ are connected to the scan line 51; the sources of the control elements T4 and T4′ are respectively connected to the odd line enable 101 and even line enable 201; the drains of the control elements T4 and T4′ are connected to gates of the switching elements T2 and T2′, respectively.

Each of the storage elements C and C′ has two ends. One end is connected to the source of the driving elements T3 and T3′ correspondingly, and the other end is connected to the connection of “the gates of the driving elements T3 and T3′” and “the drains of the write elements T2 and T2′”. The light emission elements 11 and 21 have respectively one positive electrode that connects to the drains of the driving elements T3 and T3′; and the other end forming a negative electrode that connects to the common line 53.

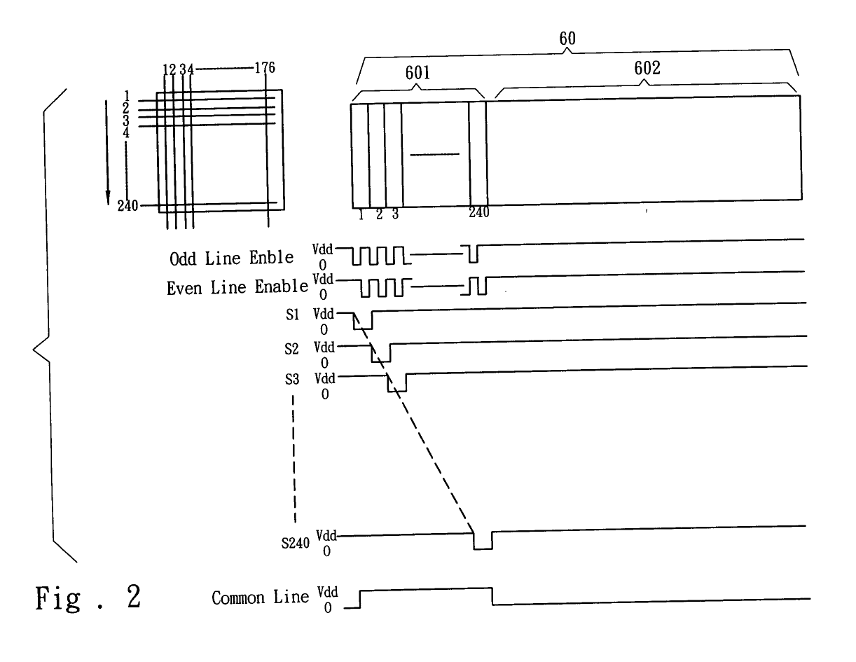

Referring to FIG. 2, which is the driving structure of the invention, the cycle of a picture frame 60 (1 frame=1/60 sec) is divided into two periods. One is a write period 601, and the other is a display period 602.

During the write period 601, the potential level of common line 53 is raised to a high potential (Vdd), and all light emission elements 11 and 21 of the panel stop displaying for the previous picture, and the data current programming operation is started from the first scan line 51 of the existing picture frame 60, and the potential difference between two ends of the storage element (C and C′) is Vsg (potential difference between the source and gate) that is required for T3 and T3′ when the current passing through the driving elements T3 and T3′ equals the data current. The process proceeds in this sequence until the last scan line 51 has completed the write operation for the data current programming. After all scan lines 51 have completed the data current programming operation, the potential of the common line 53 returns to zero (GND) so as to enter the display period 602. A current that equals the programmed data current pass through the light emission elements 11 and 21 of each pixel on the panel respectively to enable the light emission elements 11 and 21 to display the brightness of the existing picture.

The operation principle of the invention is described as follows: during the write period 601, the potential of common line 53 is raised to a high potential (Vdd), the light emission elements 11 and 21 cannot display due to reverse bias such that the currents of the light emission elements 11 and 21 are zero.

Accordingly, when the scan line 51 sends out scan driving signals, the control element T4 of the odd sub-pixel 10 and the control element T4′ of the even sub-pixel 20 are turned on. As a result, the signal of the odd enable-line 101 will turn on the writing element T1 and the switching element T2 of the odd sub-pixel 10 due to the control element T4 being turned on; and the signal of the even line enable 201 will turn off the writing element T1′ and the switching element T2′ of the even sub-pixel 20 due to the control element T4′ being turned on. Meanwhile, the data line 50 sends out the odd data current (I_{data}_{_{—}}_{odd}) of the odd sub-pixel 10.

Moreover, in the event that odd data current (I_{data}_{_{—}}_{odd}) on the data line 50 is not equal to the current (I_{T3}) flowing through the driving element T3, a current (I_{c}) will charge or discharge the storage element C, and the current is equal to the difference between the odd data current (I_{data}_{_{—}}_{odd}) and the current (I_{T3}) flowing through the driving element T3. The charging or discharging of the storage element C results in the increasing or decreasing of the current (I_{T3}) flowing through the driving element T3. And the charging or discharging of the storage element C will continue until the current (I_{T3}) flowing through the driving element T3 is equal to the odd data current □I_{data}_{_{—}}_{odd}□. When the current (I_{T3}) flowing through the driving element T3 is equal to odd data current (I_{data}_{_{—}}_{odd}), the potential difference between two ends of the storage element C offers Vsg that is required for the driving element T3 to ensure the current passing through the driving elements T3 is equal to the odd data current (I_{data}_{_{—}}_{odd}).

Thereafter, the signal of the odd line enable 101 will turned off the writing element T1 and the switching element T2 of the odd sub-pixel 10 due to the control element T4 being turned on; and the signal of the even enable-line 201 will turn on the writing element T1′ and the switching element T2′ of the even sub-pixel 20 due to the control element T4′ being turned on. Meanwhile, the data line 50 sends out the even data current (I_{data}_{_{—even}}) of the even sub-pixel 20.

At this moment, in the event that even data current (I_{data}_{_{—}}ₑᵥₑₙ) on the data line 50 is not equal to the current (I_{T3′}) flowing through the driving element T3′, a current (I_{c′}) will charge or discharge the storage element C′, and the current is equal to the difference between the even data current (I_{data}_{_{—}}ₑᵥₑₙ) and the current (I_{T3′}) flowing through the driving element T3′. The charging or discharging of the storage element C′ results in the increasing or decreasing of the current (I_{T3′}) flowing through the driving element T3′. And the charging or discharging of the storage element C′ will continue until the current (I_{T3′}) flowing through the driving element T3′ is equal to the even data current (I_{data}_{_{—}}ₑᵥₑₙ). When the current (I_{T3′}) flowing through the driving element T3′ is equal to even data current (I_{data}_{_{—}}ₑᵥₑₙ), the potential difference between two ends of the storage element C′ offers Vsg′ that is required for the driving element T3′ to ensure the current passing through the driving elements T3′ is equal to the even data current (I_{data}_{_{—}}ₑᵥₑₙ).

After all scan lines 51 have completed data current programming operation, the potential level of common line 53 returns to zero (GND) and the display period 602 starts. The light emission elements 11 and 21 is lighted due to forward bias. A current that equals the programmed data current will pass through the light emission elements 11 and 21 of each pixel on the panel respectively to enable the light emission elements 11 and 21 to display the brightness of the existing picture. The potential difference between two ends of the storage elements Cs and Cs′ respectively offers Vsg and Vsg′ that is required for the driving elements T3 and T3′ when the current passing through the driving elements T3 and T3′ equals the odd data current (I_{data}_{_{—}}_{odd}) and even data current (I_{data}_{_{—}}ₑᵥₑₙ).

In summary, the current driving apparatus for AMOLED of the invention has the following advantages:
1. The invention actualizes a driving method for data current programmed to compensate the variations of threshold voltage and electron mobility of TFT elements so as to solve the problem of image non-uniformity of the AMLOED panel.
2. The technique provided by the invention can reduce the number of required data-line 50 to half of the number required by the conventional techniques. Consequently, the cost of the circuit and the fabrication cost for bonding the modular systems may be reduced, while the robustness of modular system connection increases.
3. It is not necessary for this invention to use P-Type and N-Type CTFT LTPS manufacturing processes, thus the manufacturing cost may be reduced.
4. The invention enables OLED elements can be reverse biased for a period of time during data current programming operation. Such an operation mode can lengthen the service life of OLED elements.

1. A current driving apparatus for active matrix organic light emitting diode (AMOLED), which utilizes two abutting sub-pixels (an odd sub-pixel and an even sub-pixel). The driving apparatus of each sub-pixel includes:
odd line enable for the odd sub-pixels;
even line enable for the even sub-pixels;
a data line shared by the odd sub-pixels and the even sub-pixels;
a scan line;
a supply line;
a common line;
a writing element with the source connects to the data line;
a switching element with the gate connects to the gate of the writing element; and the source connects to the data line;
a driving element with the gate connects to the drain of the writing element; and the source connects to the supply line;
a control element with the gate connects to the scan line; and the source connects to the odd line enable (even line enable); and the drain connects to the gate of the switching element;
a storage element with two ends, one end connects to the source of the driving element; and the other end connects to the connection of the gate of the driving element and the drain of the writing element; and
a light emission element with two ends, one end is the positive electrode that connects to the drain of the driving element; and the other end is the negative electrode that connects to the common line.

2. As the current driving apparatus for active matrix organic light emitting diode of claim 1, wherein the writing element is a thin film transistor.

3. As the current driving apparatus for active matrix organic light emitting diode of claim 1, wherein the switching element is a thin film transistor.

4. As the current driving apparatus for active matrix organic light emitting diode of claim 1, wherein the driving element is a thin film transistor.

5. As the current driving apparatus for active matrix organic light emitting diode of claim 1, wherein the control element is a thin film transistor.

6. As the current driving apparatus for active matrix organic light emitting diode of claim 1, wherein the storage element is a storage capacitor.

7. A current driving method for an active matrix organic light emitting diode, which includes:
dividing a picture frame into two periods during driving, the two periods being a write period and a display period;
raising the potential of the common line to a high potential in the write period to stop light emission elements of a panel from displaying a previous picture frame, and proceed data current programmed operation from the first scan line of the existing picture frame, and the potential difference between two ends of the storage element offers Vsg (potential difference between the source and the gate) that is required for the driving element when the current passing through the driving elements equals the data current; and
returning the potential of the common line to zero (GND) so as to enter the display period after each scan line has completed the write period; and to allow a current flowing through light emission elements of each pixel on the panel to equal the programmed data current; thereby the light emission elements display at a brightness required for the picture.
